(19) United States
(12) Patent Application Publication
(10) Pub. No.: US 2011/0248967 A1
(43) Pub. Date: Oct. 13, 2011

(54) ELECTRONIC READER WITH TWO DISPLAYS AND METHOD OF TURNING PAGES THEREFOF

(75) Inventors: HAN-CHE WANG, Tu-Cheng (TW); KUAN-HONG HSIEH, Tu-Cheng (TW); HUA-DONG CHENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 12/912,761

(22) Filed: Oct. 27, 2010

(30) Foreign Application Priority Data
Apr. 9, 2010 (CN) 201010143637.8

(51) Int. Cl. G09G 5/00

(52) U.S. Cl. 345/204; 345/1.3

(57) ABSTRACT

An electronic reader includes a first display, a second display, a hinge, a comparing unit, a first sensor, a second sensor, and a swipe page unit unit. The hinge is rotatably connected to the first display and the second display. The first sensor is used for sensing the angle which the first display rotates relative to the hinge. The second sensor is used for sensing the angle which the second display rotates relative to the hinge. The comparing unit compares the rotation angles of the first display and the second display to obtain a comparison result. The swipe page unit turns one or more pages based on the comparison result and updates the first display and the second display accordingly. The disclosure also discloses a method of turning pages.

### BACKGROUND

1. Technical Field

The present disclosure relates to electronic readers and, particularly, to an electronic reader with two displays and a method of turning pages for the electronic reader.

2. Description of Related Art

Some electronic readers have two displays. Those electronic readers generally provide buttons for users to turn pages, which falls short of simulating the turning of pages with real books.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic view of an electronic reader in a full opened state, according to an exemplary embodiment.

FIG. 2 is a block diagram of the electronic reader of FIG. 1.

FIG. 3 is a schematic view of the electronic reader with a display rotated from the full opened state.

FIG. 4 is a schematic view of the electronic reader with another display rotated from the full opened state.

FIG. 5 is a schematic view of the electronic reader with both displays rotated from the full opened state.

FIG. 6A is a flowchart of a method for turning pages of the electronic reader of FIG. 1, according to an embodiment.

FIG. 6B is a flowchart of part A in FIG. 6A, according to an embodiment.

FIG. 6C is a flowchart of part B in FIG. 6A, according to an embodiment.

### DETAILED DESCRIPTION

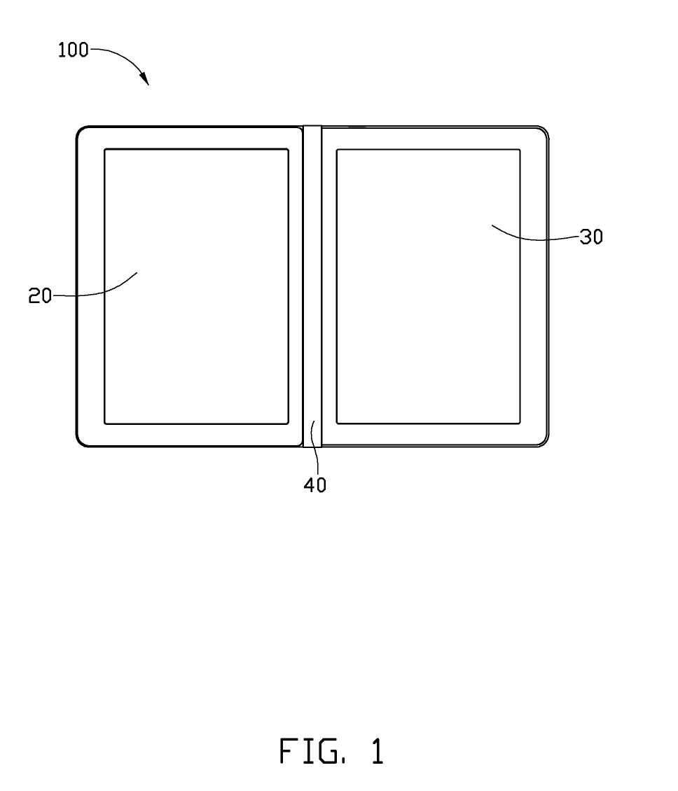

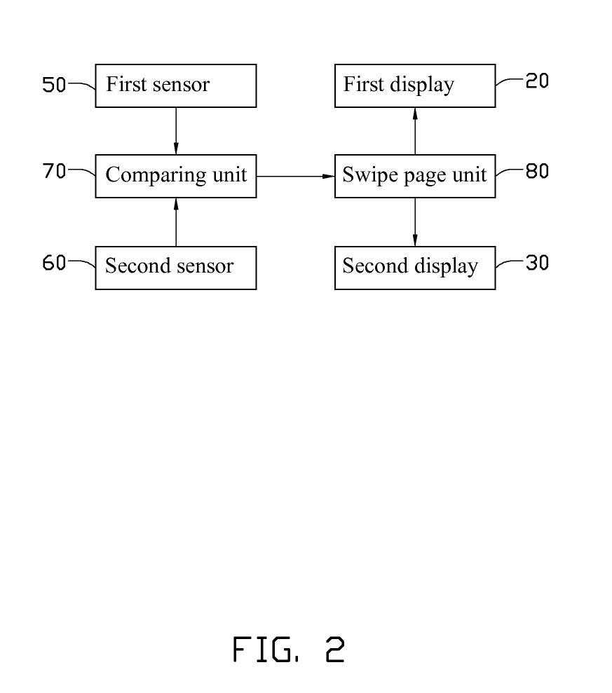

Referring to FIGS. 1 and 2, an electronic reader 10 according to an exemplary embodiment includes a first display 20, a second display 30, a hinge 40, a first sensor 50, a second sensor 60, a comparing unit 70 and a swipe page unit 80. The hinge 40 is configured for rotatably connecting the first display 20 and the second display 30 together. The first sensor 50, the second sensor 60 and swipe page unit 80 all are electronically connected to the comparing unit 70. The first display 20 and the second display 30 are both electronically connected to the swipe page unit 80.

The first sensor 50 is configured for detecting the rotation angle which the first display 20 rotates relative to the hinge 40 from the full opened state of the electronic reader 10, as shown in FIG. 1. The second sensor 60 is configured for detecting the rotation angle which the second display 30 rotates relative to the hinge 40 from the full opened state of the electronic reader 10. In an exemplary embodiment, the first sensor 50 and the second sensor 60 are both resistance angular transducers and mounted on the hinge 40. The first sensor 50 and the second sensor 60 detect resistance value variations thereof during the rotations of the hinge 40 to obtain the rotation angles of the first display 20 and the second display 30 relating to the hinge 40 from the full opened state of the electronic reader 10. The comparing unit 70 compares the rotation angles of the first display 20 and the second display 30 to obtain a comparison result. If the comparison result is that the rotation angle of the first display 20 is less than that of the second display 30, the swipe page unit 80 turns one or more pages forward and updates the first display 20 and the second display 30 accordingly. If the comparison result is that the rotation angle of the first display 20 is larger than that of the second display 30, the swipe page unit 80 turn one or more pages backward and updates the first display 20 and the second display 30 accordingly.

In an initial state, the electronic reader 10 is fully opened (i.e., in a fully opened state) with the first display 20 lies on the left side of the second display 30. The first display 20 shows the Nth page (hereinafter “page N”) and the second display 30 shows the (N+1)th page (hereinafter “page N+1”), that is, the second display 30 shows a next page of what the first display 20 shows. The initial angles of the first display 20 and the second display 30 which are detected by the first sensor 50 and the second sensor 60 are both zero.

In the exemplary embodiment, when the first display 20 rotates clockwise around the hinge 40, the rotation angle value of the first display 20 is sequentially increased. When the first display 20 rotates counter-clockwise around the hinge 40, the rotation angle value of the first display 20 is sequentially decreased. When the second display 30 rotates around the hinge 40 counter-clockwise, the rotation angle value of second display 30 is sequentially increased. When the second display 30 rotates around the hinge 40 clockwise, the rotation angle value of the second display 30 is sequentially decreased.

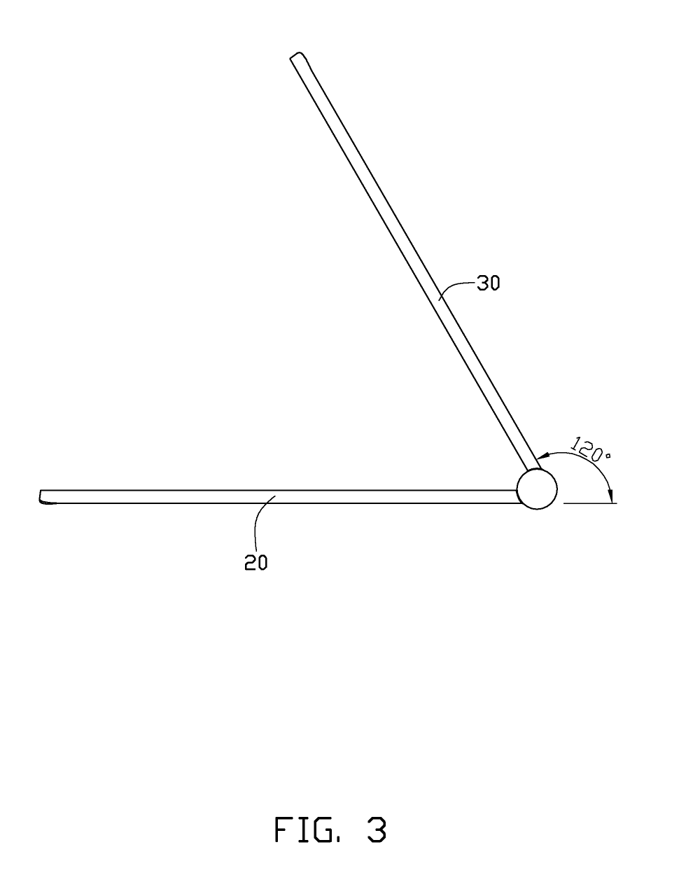

Referring to FIG. 3, the rotation angle value of the second display 30 is 120 degrees, the rotation angle value of the first display 20 is zero. The comparing unit 70 compares the rotation angle values to obtain a first comparison result. In this embodiment, the first comparison result is that the rotation angle value of the second display 30 is larger than that of the first display 20. The comparing unit 70 further compares the rotation angle value of the second display 30 with a first predetermined value based on the first comparison result to obtain a second comparison result. In this embodiment, the first predetermined value is, for instance, 60 degrees. The second comparison result is that the rotation angle value of the second display 30 is larger than the first predetermined value. The comparing unit 70 further compares the rotation angle value of the second display 30 to a second predetermined value larger than the first predetermined value based on the second comparison result to obtain a third comparison result. In this embodiment, the second predetermined value is, for example, 125 degrees. The third comparison result is that the rotation angle value of the second display 30 is less than the second predetermined value. The comparison unit 70 sends an advance page forward signal to the swipe page unit 80 according to the third comparison result. The swipe page unit 80 advances one page forward based on the turn one page forward signal and controls the first display 20 and the second display 30 to show pages immediately following the current pages, that is, the first display 20 shows page N+2 and the second display 30 shows page N+3. If the rotation angle value of the second display 30 is 140 degrees which is larger than the second predetermined value, the comparison unit 70 sends a skip pages forward signal to the swipe page unit 80. The swipe page unit 80 turns a predetermined number of pages forward based on the skip pages forward signal and controls the first display 20 and the second display 30 to show pages after the predetermined number of pages. In this embodiment, the swipe page unit 80 advances three pages forward and controls the first display 20 to shows page N+4 and the second display 30 to show page N+5.

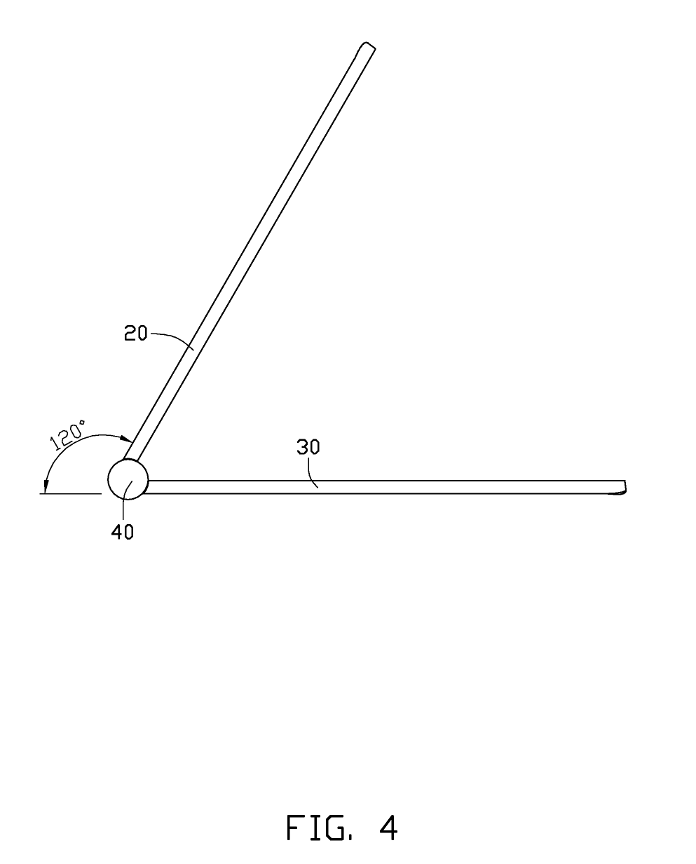

Referring to FIG. 4, the rotation angle value of the first display 20 is 120 degrees, the rotation angle value of the second display 30 is zero. The comparing unit 70 compares the rotation angle values to obtain a fourth comparison result. The fourth comparison result is that the rotation angle value of the first display 20 is larger than that of the second display 30. The comparing unit 70 further compares the rotation angle value of the first display 20 with a third predetermined value based on the fourth comparison result to obtain a fifth comparison result. In this embodiment, the third predetermined value is, for example, 70 degrees. The fifth comparison result is that the rotation angle value of the first display 20 is larger than the third predetermined value. The comparing unit 70 further compares the rotation angle value of the first display 20 to a fourth predetermined value larger than the third predetermined value based on the fifth comparison result to obtain a sixth comparison result. In this embodiment, the fourth predetermined value is 130 degrees. The sixth comparison result is that the rotation angle value of the first display 20 is less than the fourth predetermined value. The comparison unit 70 sends a rewind one page backward signal to the swipe page unit 80 according to the sixth comparison result. The swipe page unit 80 turns one page backward based on the rewind one page backward signal and controls the first display 20 and the second display 30 to show pages immediately preceding the current pages, that is, the first display 20 shows page N−2 and the second display 30 shows N−1. If the rotation angle value of the first display 20 is 140 degree which is larger than the fourth predetermined value, the comparison unit 70 sends a skip pages backward signal to the swipe page unit 80. The swipe page unit 80 turns a predetermined number of pages backward based on the skip pages backward signal and controls the first display 20 and the second display 30 to show pages before the predetermined number of pages. In this embodiment, the swipe page unit 80 turns three pages backward and controls the first display 20 to show page N−4 and the second display 30 to show page N−3.

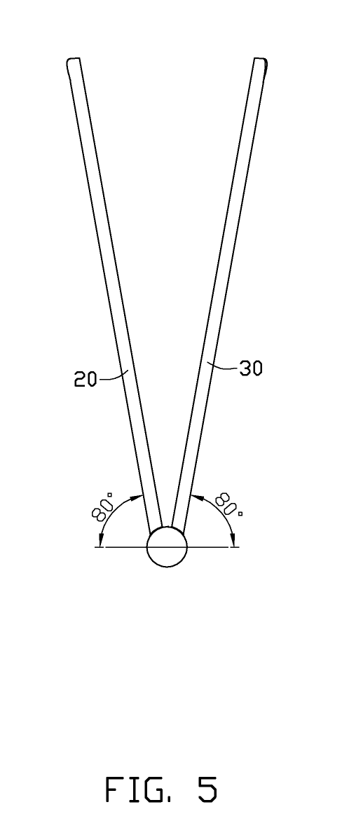

Referring to FIG. 5, the rotation angle value of the first display 20 and the second display 30 are both 80 degrees. The comparing unit 70 compares the rotation angle values to obtain a comparison result. The comparison result is that the rotation angle value of the first display 20 is equal to that of the second display 30. The comparing unit 70 doesn't send any signal to the swipe page unit 80. The first display 20 and the second display 30 keep showing the current pages correspondingly.

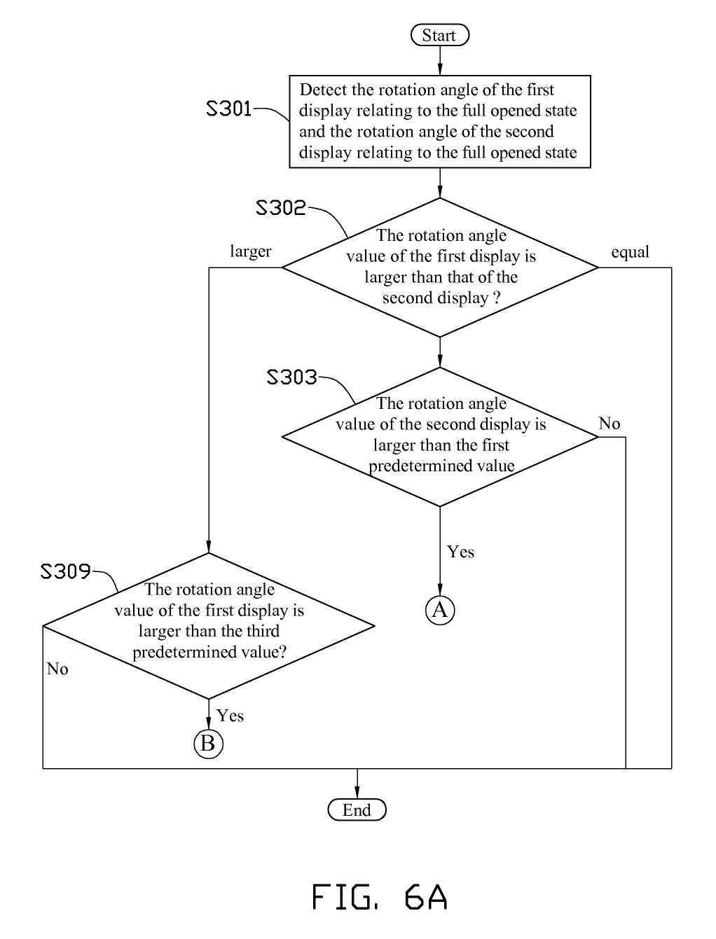

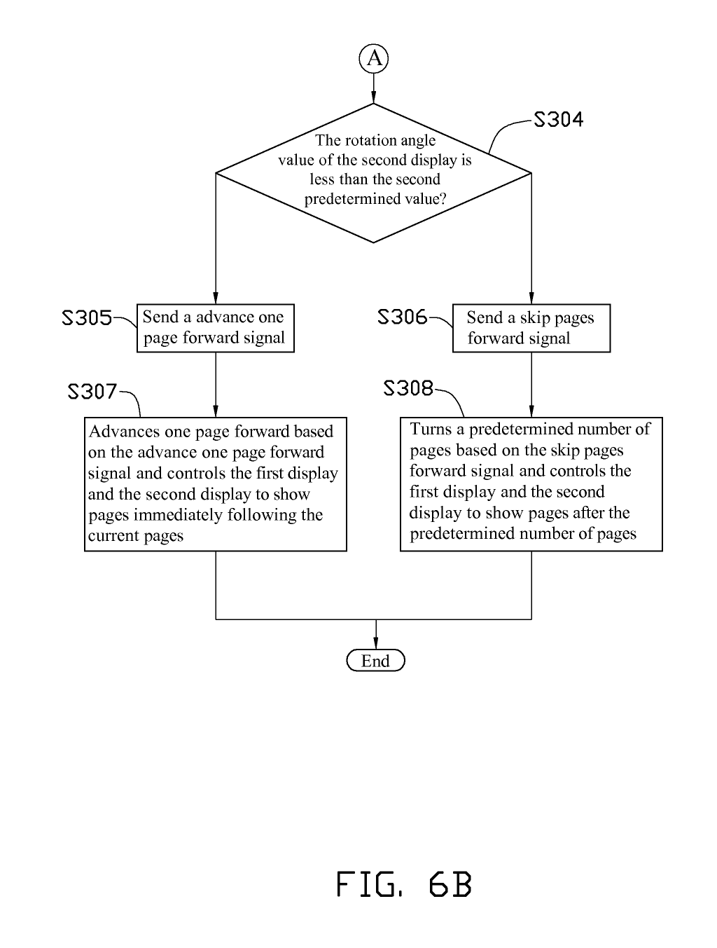

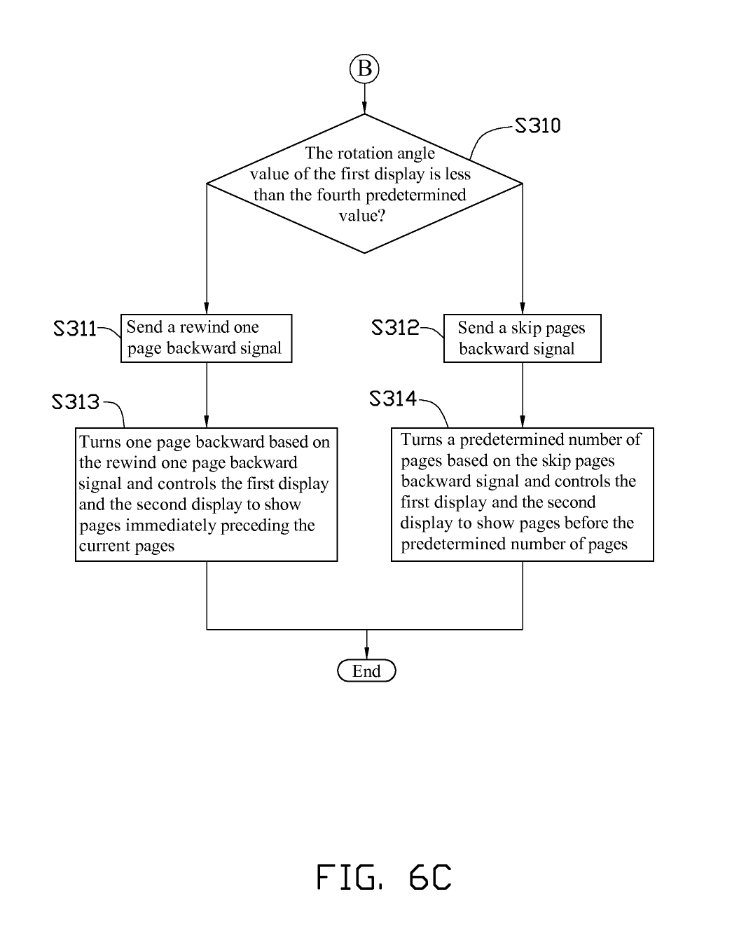

Referring to FIGS. 6A to 6C, a flowchart of a method for turning pages of the electronic reader 10 is provided.

In step S301, the first sensor 50 and the second sensor 60 respectively detect the rotation angle of the first display 20 relating to the full opened state and the rotation angle of the second display 30 relating to the full opened state.

In step S302, the comparing unit 70 compares the rotation angle value of the first display 20 to that of the second display 30. If the rotation angle value of the first display 20 is less than that of the second display 30, the procedure goes to step S303. If the rotation angle value of the first display 20 is larger than that of the second display 30, the procedure goes to step S309. If the rotation angle value of the first display 20 is equal to that of the second display 30, the procedure ends.

In step S303, the comparing unit 70 compares the rotation angle value of the second display 30 to a first predetermined value. If the rotation angle value of the second display 30 is larger than the first predetermined value, the procedure goes to step S304, otherwise the procedure ends.

In step S304, the comparing unit 70 compares the rotation angle value of the second display 30 to a second predetermined value which is larger than the first predetermined value. If the rotation angle value of the second display 30 is less than the second predetermined value, the procedure goes to step S305, otherwise the procedure goes to step S306.

In step S305, the comparison unit 70 sends an advance page forward signal to the swipe page unit 80.

In step S306, the comparison unit 70 sends a skip pages forward signal to the swipe page unit 80.

In step S307, the swipe page unit 80 advances one page forward based on the turn one page forward signal and controls the first display 20 and the second display 30 to show pages immediately following the current pages.

In step S308, the swipe page unit 80 turns a predetermined number of pages forward based on the skip pages forward signal and controls the first display 20 and the second display 30 to show pages after the predetermined number of pages. In this embodiment, in an initial state, the first display 20 shows page N and the second display 30 shows page N+1. In the current state, the swipe page unit 80 advances three pages forward and controls the first display 20 to shows page (N+4) and the second display 30 to show page N+5.

In step S309, the comparing unit 70 compares the rotation angle value of the first display 20 to a third predetermined value. If the rotation angle value of the first display 20 is larger than the third predetermined value, the procedure goes to step S310, otherwise the procedure ends.

In step S310, the comparing unit 70 compares the rotation angle value of the first display 20 to a fourth predetermined value which is larger than the third predetermined value. If the rotation angle value of the first display 20 is less than the fourth predetermined value, the procedure goes to step S311, otherwise the procedure goes to step S312.

In step S311, the comparison unit 70 sends a rewind page backward signal to the swipe page unit 80.

In step S312, the comparison unit 70 sends a skip pages backward signal to the swipe page unit 80.

In step S313, the swipe page unit 80 turns one page backward based on the rewind page backward signal and controls the first display 20 and the second display 30 to show pages immediately preceding the current pages.

In step S314, the swipe page unit 80 turns a predetermined number of pages based on the skip pages backward signal and controls the first display 20 and the second display 30 to show pages before the predetermined number of pages. In this embodiment, in an initial state, the first display 20 shows page N and the second display 30 shows page N+1. In the current state, the swipe page unit 80 turns three pages backward and controls the first display 20 to show page N−4 and the second display 30 to show page N−3.

It is to be understood, however, that even though numerous characteristics and advantages of the present disclosure have been set fourth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic reader, comprising:
a first display;
a second display;
a hinge rotatably connecting the first display to the second display;
a first sensor to detect the rotation angle which the first display rotates relative to the hinge;
a second sensor to detect the rotation angle which the second display rotates relative to the hinge;
a comparing unit comparing the rotation angles of the first display and the second display to obtain a first comparison result; and
a swipe page unit;
wherein if the first comparison result is that the rotation angle of the first display is less than that of the second display, the swipe page unit turns one or more pages forward based on the first comparison result and updates the first display and the second display accordingly.

2. The electronic reader as described in claim 1, wherein the first sensor is a resistance angular transducer and mounted on the hinge.

3. The electronic reader as described in claim 1, wherein the second sensor is a resistance angular transducer and mounted on the hinge.

4. The electronic reader as described in claim 1, wherein when the first comparison result is that the rotation angle of the first display is less than that of the second display, the comparing unit further compares the rotation angle of the second display with a first predetermined value to obtain a second comparison result, if the second comparison result is that the rotation angle of the second display is larger than the first predetermined value, the swipe page unit advances one page one or more pages forward based on the second comparison result and updates the first display and the second display accordingly.

5. The electronic reader as described in claim 4, wherein when the second comparison is that the rotation angle of the second display is larger than the first predetermined value, the comparing unit further compares the rotation angle of the second display to a second predetermined value which is larger than the first predetermined value to obtain a third comparison result, if the third comparison result is that the rotation angle of the second display is less than the second predetermined value, the swipe page unit advances one page forward based on the third comparison result and controls the first display and the second display to show pages immediately following the current pages, otherwise the swipe page unit turns a predetermined number of pages forward based on the third comparison result and controls the first display and the second display to show pages after the predetermined number of pages.

6. The electronic reader as described in claim 1, wherein if the first comparison result is that the rotation angle of the first display is larger than that of the second display, the swipe page unit turns one or more pages backward based on the first comparison result and updates the first display and the second display.

7. The electronic reader as described in claim 6, wherein when the first comparison result is that the rotation angle of the first display is larger than that of the second display, the comparing unit further compares the rotation angle of the first display to a third predetermined value to obtain a fourth comparison result, if the fourth comparison result is that the rotation angle of the first display is larger than the third predetermined value, the swipe page unit turns one or more pages backward based on the fourth comparison result and updates the first display and the second display accordingly.

8. The electronic reader as described in claim 7, wherein when the fourth comparison result is that the rotation angle of the first display is larger than the third predetermined value, the comparing unit further compares the rotation angle of the first display to a fourth predetermined value which is larger than the third predetermined value to obtain a fifth comparison result, if the fifth comparison result is that the rotation angle of the first display is less than the fourth predetermined value, the swipe page unit turns one page backward based on the fifth comparison result and controls the first display and the second display to show pages immediately preceding the current pages, otherwise the swipe page unit turns a predetermined number of pages backward based on the fifth comparison result and controls the first display and the second display to show pages before the predetermined number of pages.

9. A method of turning pages for an electronic reader with a first display and a second display rotatably connecting to the second display, comprising:
detecting a rotation angle of the first display rotating to the full opened state of the electronic reader and a rotation angle of the second display rotating to the full opened state of the electronic reader;
comparing the rotation angle value of the first display to that of the second display to obtain a first comparison result; and
turning one or more pages forward and updating the first display and the second display accordingly if the first comparison result is that the rotation angle of the first display is less than that of the second display.

10. The method of turning pages as described in claim 9, wherein when the first comparison result is that the rotation angle of the first display is less than that of the second display, further comprising:
comparing the rotation angle value of the second display to a first predetermined value to obtain a second comparison result, advancing one page or more pages forward and updating the first display and the second display accordingly if the second comparison result is that the rotation angle value of the second display is larger than the first predetermined value.

11. The method of turning pages as described in claim 10, wherein when the second comparison result is that the rotation angle of the second display is larger than the first predetermined value, further comprising:
comparing the rotation angle value of the second display to a second predetermined value which is larger than the first predetermined value to obtain a third comparison result, if the third comparison result is that the rotation angle value of the second display is less than the second predetermined value, advancing one page forward controlling the first display and the second display to show pages immediately following the current pages, otherwise turning a predetermined number of pages forward based on the third comparison result and controlling the first display and the second display to show pages after the predetermined number of pages.

12. A method of turning pages for an electronic reader with a first display and a second display rotatably connecting to the second display, comprising:
detecting a rotation angle of the first display rotating to the full opened state of the electronic reader and a rotation angle of the second display rotating to the full opened state of the electronic reader;
comparing the rotation angle value of the first display to that of the second display to obtain a first comparison result; and
turning one or more pages backward and updating the first display and the second display accordingly if the first comparison result is that the rotation angle of the first display is larger than that of the second display.

13. The method of turning pages as described in claim 12, wherein when the first comparison result is that the rotation angle of the first display is larger than that of the second display, further comprising:
comparing the rotation angle value of the first display to a first predetermined value to obtain a second comparison result, turning one or more pages page backward and updating the first display and the second display accordingly if the second comparison result is that the rotation angle of the first display is larger than the first predetermined value.

14. The method of turning pages as described in claim 13, wherein when the second comparison result is that the rotation angle of the first display is larger than the first predetermined value, further comparing the rotation angle value of the first display to a second predetermined value which is larger than the first predetermined value to obtain a third comparison result, if the third comparison result is that the rotation angle of the first display is less than the second predetermined value, turning one page backward based on the third comparison result and controlling the first display and the second display to show pages immediately preceding the current pages, otherwise turning a predetermined number of pages backward based on the third comparison result and controlling the first display and the second display to show pages before the predetermined number of pages.
